(19) United States
(12) Patent Application Publication
(10) Pub. No.: US 2008/0198619 A1
(43) Pub. Date: Aug. 21, 2008

(54) Backlight module with tubes

(75) Inventors: Ming-Chuan Chen, Yangmei Taoyuan (TW); Kuo-Ann Chu, Yangmei Taoyuan (TW)

Correspondence Address: TROXELL LAW OFFICE PLLC, SUITE 1404, 5205 LEESBURG PIKE, FALLS CHURCH, VA, 22041, US

(73) Assignee: K-BRIDGE ELECTRONICS CO., LTD.

(21) Appl. No.: 11/798,043

(22) Filed: May 9, 2007

(30) Foreign Application Priority Data
Feb. 15, 2007 (TW) 096105581

(51) Int. Cl. F21S 4/00

(52) U.S. Cl. 362/559; 362/581

(57) ABSTRACT

A tube installation of a backlight module allowing fast and easy assembly and disassembly of tube without depending on a soldering process is comprised of a substrate, multiple tubes and a locating means; a terminal of each tube being provided with a conductor comprised of a first bending portion and a second bending portion with a terminal of the second bending portion serving as a contact portion; the locating means being placed below the substrate for the contact portion to contact the substrate so to secure the tube to where above the substrate.

### BACKGROUND OF THE INVENTION

(a) Field of the Invention

The present invention is related to a backlight module with tubes, and more particularly to one that allows easy assembly and disassembly of tubes to and from the backlight module without depending on a soldering process.

(b) Description of the Prior Art

In the awareness of spatial utilization and low radiation to ensure of human health for the user, conventional TV set and CRT computer display have been gradually exited by new generation of LCD and liquid crystal TV set. The liquid crystal display (LCD) involves placement of a liquid-status crystal between two sheets of glass in parallel with each other; multiple minute electric wires vertically and horizontally arranged between those two sheets of glass; and whether those electric wires are conducted or not controls rod-shaped crystal molecules to change direction to refract light and display picture. The cathode ray tube (CRT) operates on negative voltage released from cathode coils disposed at rear end of a display to drive an electronic gun to strike electronic beam onto an arc glass fully coated with phosphide. Therefore, while achieving the design purpose of being compact, the LCD significantly reduce radiation from the electric gun among others.

However, in terms of service life, the LCD is inferior to the conventional CRT. The primary cause is that a cold cathode tube remains the primary light source of the backlight module. With a given amount of consumption, spots will develop on the tube to compromise image refraction effects of light streams. As illustrated in FIG. 1 of the accompanying drawings, on considering the fact that a cold cathode tube 12 is slim and fragile, each of both sides of a substrate 13 where wiring takes place must be first disposed with a support 14 in connecting the backlight module to an external source output terminal 11. Upon inserting each and all cathode tubes through both supports 14, each input terminal 121 of the cold cathode tube 12 and the external source output terminal 11 are soldered at a soldering point 15. However, in case of any cold cathode tube 12 breaks or develops spot damage, the soldering point 15 must be first removed before inserting and soldering in place a new cold cathode tube 12 to proceed subsequent wiring. Maintenance does create quite a problem to a user and the wiring problem usually causes a damaged backlight module (even there is only one cold cathode tube is damaged) to be waived. As a result, the LCD fails to survive its expected service lift and the earlier retired LCD also presents environmental problem.

As illustrated in FIG. 2, another construction of connecting a cold cathode tube includes a control circuit board 21, one or a plurality of cold cathode tube 22 connected to the control circuit board 21, one or a plurality of electrode pin 221 disposed to each cold cathode tube 22, one or a plurality of socket 211 disposed on the control circuit board 21 electrically connected to a circuit 212 on the control circuit board 21, and a plug 222 disposed on a terminal of each cold cathode tube 22 to be integrated with the extended electrode pin 221. Accordingly, each plug 222 is inserted into its corresponding socket 211 for each cold cathode tube 22 to electrically connect to the control circuit board 21.

However, the construction of having the cold cathode tube 22 to electrically connect to the control circuit board 21 is achieved by means of the socket 211 and the plug 222 is found with the following flaws:

1. Increased production cost due to installation of the socket and the plug, plus additional costs incurred from material preparation, purchase and inspection; and

2. The mated socket and plug causes the otherwise flushed control circuit board to show abrupt protrusion to limit space available for accommodation other parts and components.

### SUMMARY OF THE INVENTION

The primary purpose of the present invention is to provide a backlight module with tubes that is environment friendly and allows easy assembly and disassembly of the tubes without depending on soldering.

To achieve the purpose, the backlight module with tubes includes a substrate, multiple tubes, and a locating means. A conductor disposed to a terminal of each tube is comprised of a first bending portion and a second bending portion with a terminal of the second bending portion serving as a contact portion; a substrate rests on the contact portion; and the locating means is placed beneath the substrate to secure the tube on top of the substrate.

### BRIEF DESCRIPTION OF THE DRAWINGS

FIG. 1 is a schematic view of a tube wiring construction of the prior art.

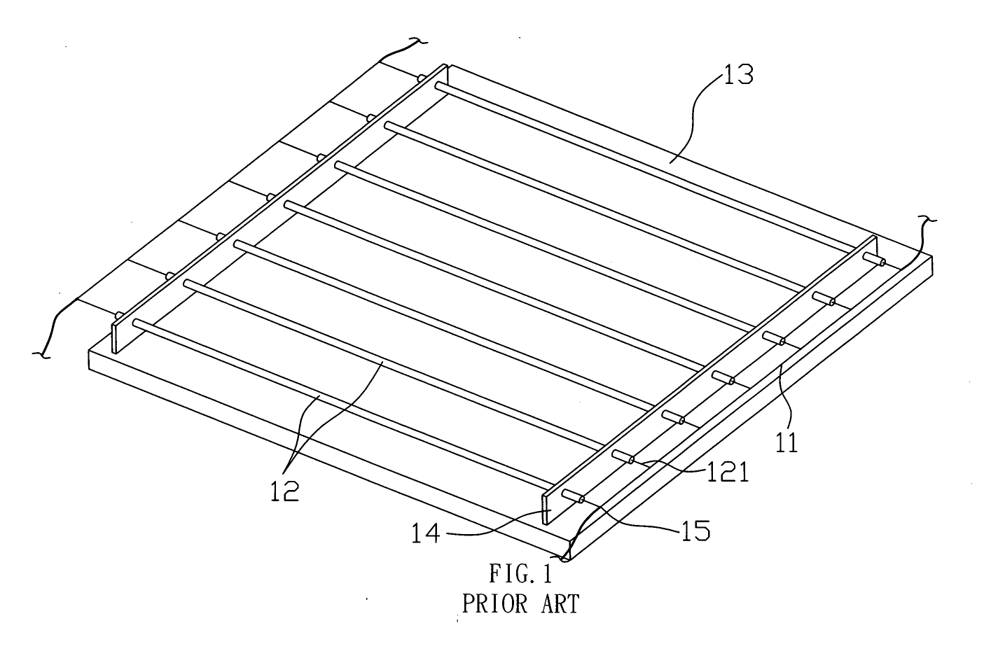

FIG. 2 is a schematic view of a tube wiring construction of another prior art.

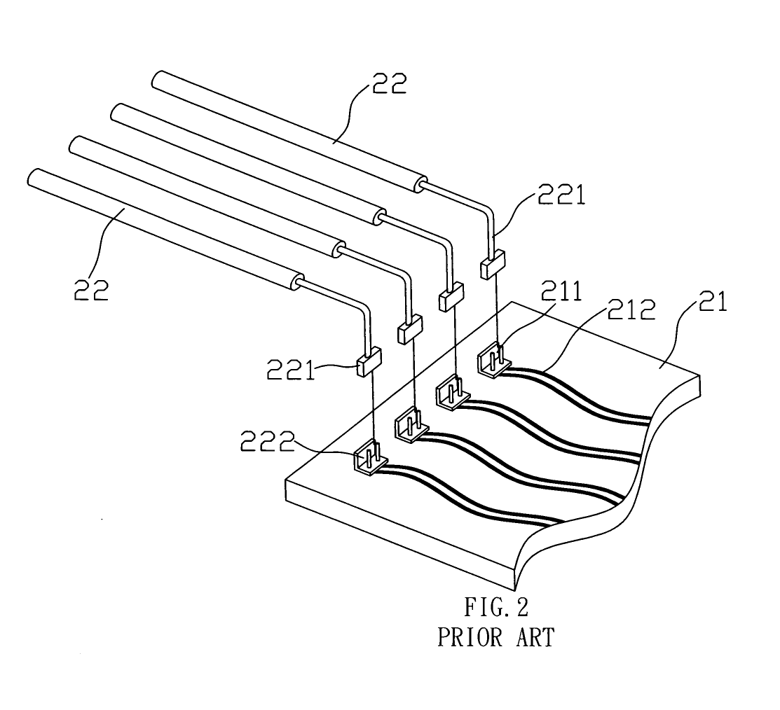

FIG. 3 is a schematic view of a tube installation of the present invention.

FIG. 4 is a perspective view showing a single tube construction of the present invention.

FIG. 5 is an exploded view of a construction of a tube and a locating device of the present invention.

FIG. 6 is a schematic view showing the construction of the tube and the locating device of the present invention.

FIG. 7 is a perspective view of a construction of the tube located to a substrate of the present invention.

FIG. 8 is a schematic view of a construction of a contact and a retaining portion of the present invention.

FIG. 9 is a perspective view of a construction of the tube and an insertion member of the present invention.

### DETAILED DESCRIPTION OF THE PREFERRED EMBODIMENTS

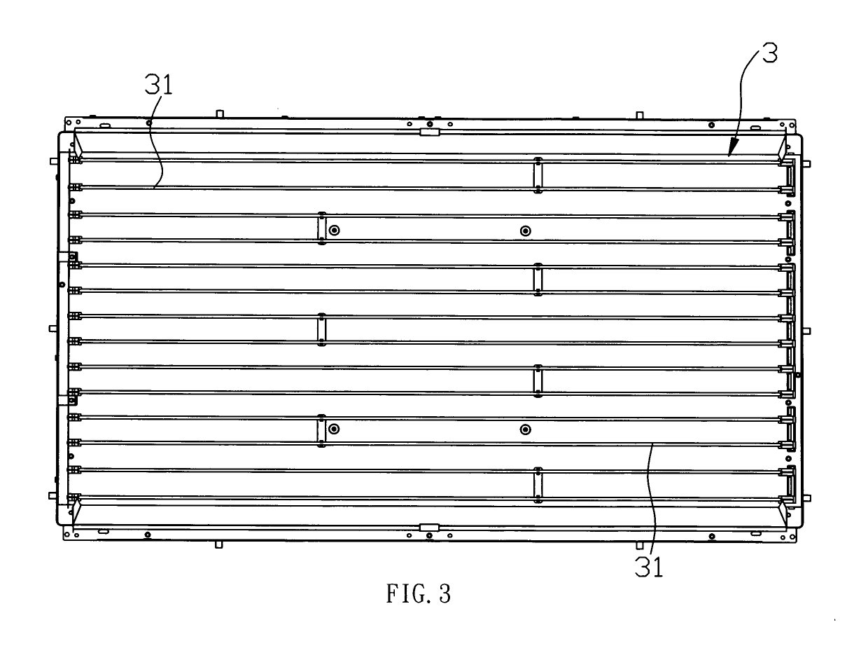

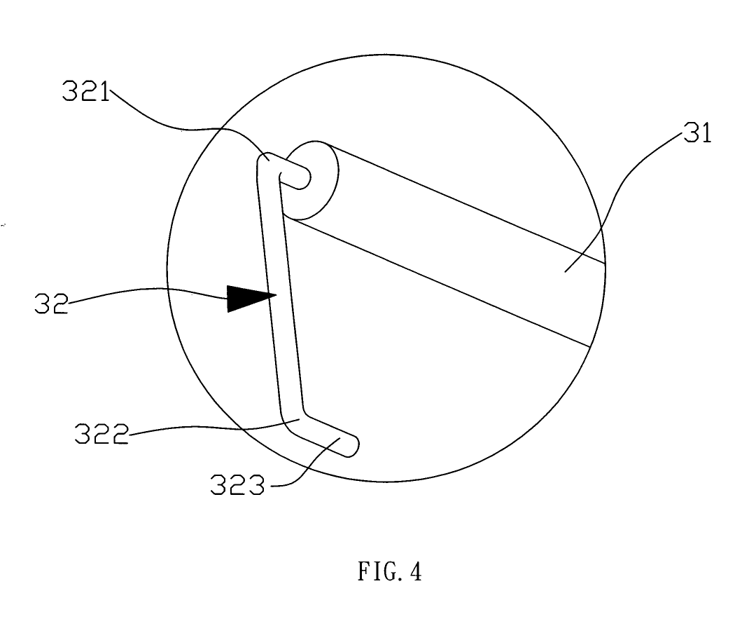

Referring to FIGS. 3 and 4 for a basic construction of a tube installation 3 in a backlight module with tubes of the present invention, the tube installation 3 includes multiple tubes 31. A terminal of each tube 31 is disposed with a conductor 32 comprised of a first bending portion 321 and a second bending portion 322 with a terminal of the second bending portion 322 serving as a contact portion 323.

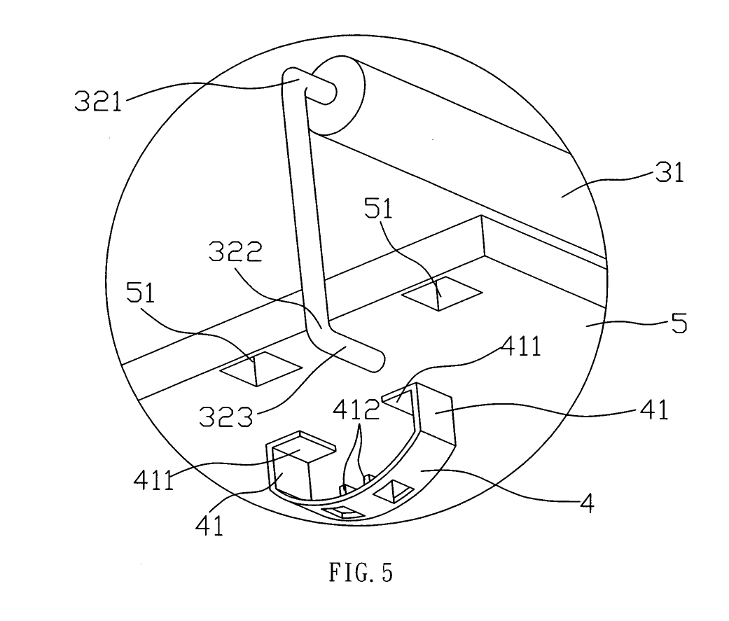

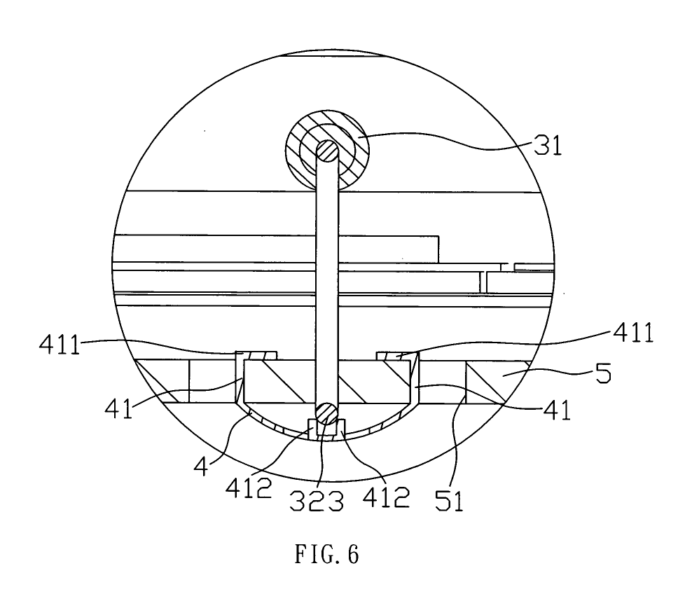

With the tube installation 3 adapted in the backlight module, a locating means 4 is placed on a substrate 5 as illustrated in FIG. 5 and FIG. 6. Multiple locating holes 41 are disposed on the substrate 5 and a locating plate 41 extending into a locating hole is disposed to the locating means 4. A latching portion 411 further extends from the locating plate 41 to buckle up the substrate 5 through the locating hole 51.

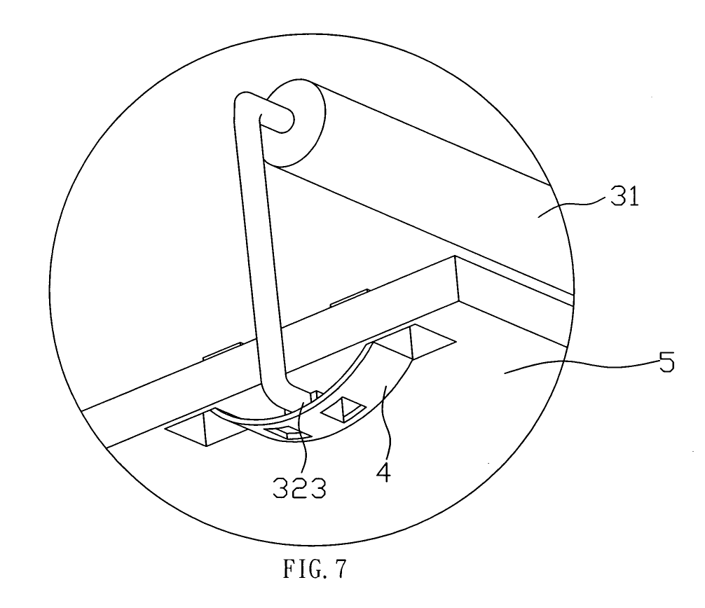

To assemble, the tube 31 is placed on top of the substrate 5 and is secured beneath the substrate 5 with the locating means 4. Wherein, the locating plate 41 is first inserted into the locating hole 51 and secured therein by having the latching portion 411 to buckle up in the locating hole 51. The contact portion of the locating means 4 is provided with two limiting portions 412 to restrict the contact portion 323 on both sides of the contact portion 323 to ensure its firm contact with the substrate 5. As illustrated in FIG. 7, the tube 31 contacts the substrate 5 at where beneath the substrate 5 for contact portion 323 of the conductor 32 to electrically connect to a circuit provided on the substrate 5.

Compared with the prior art, the present invention provides the following advantages:

1. All tubes are disposed on top of the substrate and contact the substrate at where beneath the substrate to keep a surface of the substrate flushed and smooth without causing limitation to the space available for accommodation other parts and component.

2. The electric connection between the tube and the substrate is achieved without depending on a soldering process to prevent environmental problem caused by soldering tin.

3. Each individual tube allows fast and easy assembly and disassembly with the locating means to facilitate maintenance of the backlight module and its tubes.

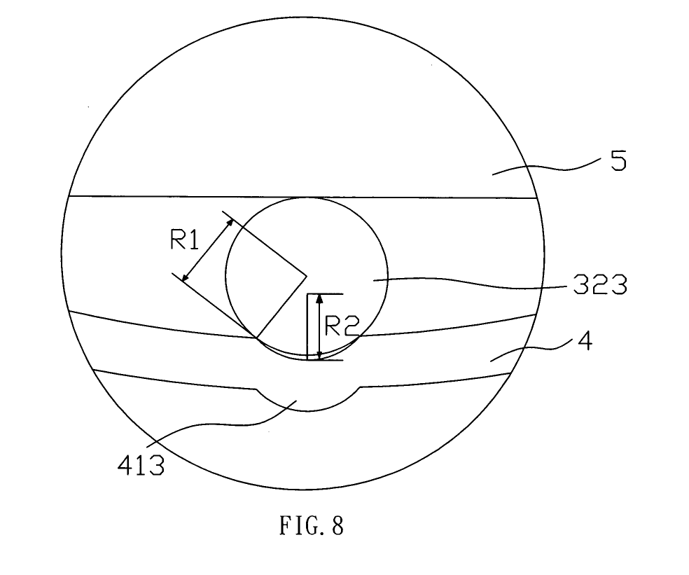

Furthermore, a retaining portion 413 as illustrated in FIG. 8 is formed on the locating means 4 towards the contact portion 323. The retaining portion 413 disposed above the contact portion 323 relates to an arc shape in an radius (R2) smaller than a radius (R1) of the conductor 32 or contact portion 323 for the retaining portion 413 to tightly hold against where above the contact portion 323 thus to ensure firm contact of the contact portion 323 with the substrate 5

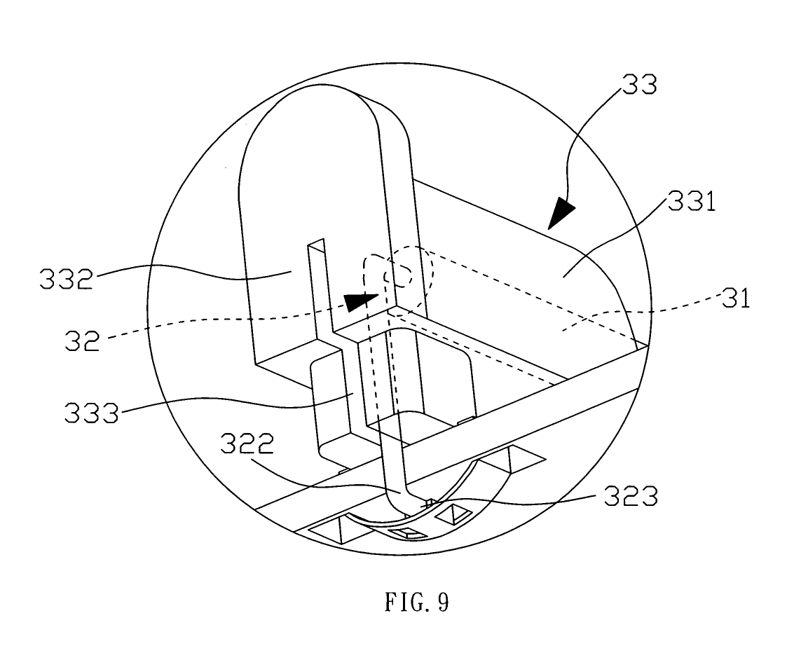

An insertion member 33 made of silicone gel as illustrated in FIG. 9 is inserted onto a terminal of the tube 31. The insertion member 33 is provided with a first cladding portion 331 and a second cladding portion 332 to respectively envelop the terminal of the tube 31 and the conductor 32 leaving the second bending portion 322 and the contact portion 323 exposed. A slot 33 is disposed in the second cladding portion 332 to accommodate the conductor 32 for the insertion member 33 to protect the conductor 32.

The prevent invention provides a backlight module with tubes that is capable of realizing its purposes as described, and the application for a patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A backlight tube installation comprising a substrate, multiple tubes with a terminal of each tube disposed with a conductor provided with a first bending portion and a second bending portion with a terminal of the second bending portion serving as a contact portion; and a locating means to secure the tube to where above the substrate by having the contact portion to contact the substrate at where beneath the substrate.

2. The backlight tube installation as claimed in claim 1, wherein multiple locating holes are disposed on the substrate; a locating plate to extend into the locating hole is disposed to the locating means; and a latching portion extends from the locating plate to buckle up in the locating hole to secure the locating means in place.

3. The backlight tube installation as claimed in claim 1, wherein two limiting portions are formed on the locating means towards the contact portion to latch both sides of the contact portion.

4. The backlight tube installation as claimed in claim 1, wherein a retaining portion is disposed to the locating means towards the contact portion and is located on top of the contact portion.

5. The backlight tube installation as claimed in claim 4, wherein the retaining portion is made in an arc form and in a radius smaller than that of the conductor.

6. The backlight tube installation as claimed in claim 1, wherein an insertion member is inserted onto a terminal of the tube.

7. The backlight tube installation as claimed in claim 6, wherein the insertion member is provided with a first cladding portion and a second cladding portion to respectively envelop the tube and the conductor leaving the second bending portion and the contact portion exposed.

8. The backlight tube installation as claimed in claim 7, wherein a slot is disposed to the second cladding portion to accommodate the conductor.

9. The backlight tube installation as claimed in claim 6, wherein the insertion member is made of silicone gel.

10. A tube installation comprising multiple tubes with a terminal of each tube disposed with a conductor; the conductor being provided with a second bending portion and a second bending portion with a terminal of the second bending portion serving as a contact portion.

11. The tube installation as claimed in claim 10, wherein each tube being secured to a substrate by means of a locating means.

12. The backlight tube installation as claimed in claim 11, wherein multiple locating holes are disposed on the substrate; a locating plate to extend into the locating hole is disposed to the locating means; and a latching portion extends from the locating plate to buckle up in the locating hole.

13. The backlight tube installation as claimed in claim 11, wherein two limiting portions are formed on the locating means towards the contact portion to latch both sides of the contact portion.

14. The backlight tube installation as claimed in claim 11, wherein a retaining portion is disposed to the locating means towards the contact portion and is located on top of the contact portion.

15. The backlight tube installation as claimed in claim 14, wherein the retaining portion is made in an arc form and in a radius smaller than that of the conductor.

16. The backlight tube installation as claimed in claim 10, wherein an insertion member is inserted onto a terminal of the tube.

17. The backlight tube installation as claimed in claim 16, wherein the insertion member is provided with a first cladding portion and a second cladding portion to respectively envelop the tube and the conductor leaving the second bending portion and the contact portion exposed.

18. The backlight tube installation as claimed in claim 17, wherein a slot is disposed to the second cladding portion to accommodate the conductor.

19. The backlight tube installation as claimed in claim 16, wherein the insertion member is made of silicone gel.
